(19) United States
(12) Patent Application Publication
(10) Pub. No.: US 2025/0306928 A1
(43) Pub. Date: Oct. 2, 2025

(54) LOAD INSTRUCTION DIVISION

(71) Applicant: Advanced Micro Devices, Inc., Santa Clara, CA (US)

(72) Inventors: Alexander Toufic Freij, Austin, TX (US); Heather Lynn Hanson, Austin, TX (US); Onur Kayiran, West Henrietta, NY (US); Patrick J. Shyvers, Fort Collins, CO (US); Smriti Ojha, Santa Clara, CA (US); Travis Boraten, Austin, TX (US); Yasuko Eckert, Bellevue, WA (US)

(73) Assignee: Advanced Micro Devices, Inc., Santa Clara, CA (US)

(21) Appl. No.: 18/622,265

(22) Filed: Mar. 29, 2024

(51) Int. Cl. G06F 9/30; G06F 9/38

(52) U.S. Cl. CPC G06F 9/30043; G06F 9/30079; G06F 9/30181; G06F 9/3867

(57) ABSTRACT

The disclosed computing device can identify multiple loads, from contiguous memory locations into respective registers, that have been fused into a load instruction sequence. The computing device can split the contiguous memory locations into separate load instructions for each register to generate a split load instruction sequence that replaces the fused load instruction sequence. Various other methods, systems, and computer-readable media are also disclosed.

### BACKGROUND

Ever increasing computing demands require improved computing performance from computing devices. Improving computing performance can include improving computing efficiency, for example by identifying and alleviating certain computing bottlenecks in a computing device. For instance, in some computing workloads such as memory-bound workloads (e.g., workloads which require a high ratio of load operations from memory/cache as compared to other operations such that latency for the load operations to complete can limit other operations), the bottlenecks can occur for loading data and more specifically loading data from cache. However, addressing these loading bottlenecks can, in some instances, create or exacerbate inefficiencies in other types of workloads, such as compute-intensive workloads (e.g., workloads which require a high ratio of arithmetic/logic operations as compared to other operations such that a high usage of execution units can limit other operations).

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for load instruction division.

FIG. 2 is a flow diagram of an exemplary instruction pipeline.

FIGS. 3A-C are diagrams of exemplary load instruction division.

FIG. 4 is a flow diagram of an exemplary method for load instruction division.

FIG. 5 is a flow diagram of another exemplary method for load instruction division.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to dividing load instructions. As will be explained in greater detail below, implementations of the present disclosure identify a larger load instruction (e.g., having multiple register destinations) that can be divided and accordingly divide the larger load instruction into smaller load instructions (e.g., fewer register destinations) based on splitting contiguous memory locations into the separate smaller load instructions. By splitting load instructions, the systems and methods provided herein advantageously improve the functioning of a computer itself, for instance by reducing a number of additional instructions needed for incorporating the larger load instruction. The systems and methods provided herein also improve computing efficiency and performance of compute intensive workloads.

In one implementation, a device for load instruction division includes a control circuit configured to generate, based on a first load instruction sequence, a second load instruction sequence having a number of load instructions that is greater than a number of load instructions of the first load instruction sequence, and replace the first load instruction sequence with the second load instruction sequence in an instruction pipeline.

In some examples, generating the second load instruction sequence includes converting a load instruction for contiguous memory locations in the first load instruction sequence into separate load instructions for the contiguous memory locations. In some examples, the control circuit is configured to replace the first load instruction sequence with the second load instruction sequence before a decode stage of the instruction pipeline. In some examples, replacing the first load instruction sequence with the second load instruction sequence further comprises replacing the first load instruction sequence with the second load instruction sequence in an operation cache.

In some examples, replacing the first load instruction sequence with the second load instruction sequence further includes storing the second load instruction sequence in an operation cache that stores the first load instruction sequence to decode a load macro-operation, and selecting the second load instruction sequence when decoding the load macro-operation.

In some examples, the control circuit is further configured to replace the first load instruction sequence with the second load instruction sequence in response to a performance-based trigger. In some examples, the performance-based trigger corresponds to a load-store unit (LSU) utilization rate being below an LSU utilization rate threshold and a micro-operation dispatch rate exceeding a micro-operation dispatch rate threshold. In some examples, the performance-based trigger corresponds to a distribution of load sources. In some examples, the performance-based trigger corresponds to a memory traffic for a memory controller satisfying a memory traffic threshold. In some examples, the first load instruction sequence corresponds to a scalar. In some examples, the first load instruction sequence corresponds to a vector.

In one implementation, a system for load instruction division includes a memory, a processor having a plurality of registers, and a control circuit. The control circuit can be configured (i) to identify a fused load instruction sequence for the plurality of registers that includes a load instruction for loading from multiple memory locations (ii) generate a split load instruction sequence by converting the load instruction into separate load instructions for each of the multiple memory locations into respective registers of the plurality of registers, and (iii) replace the fused load instruction sequence with the split load instruction sequence.

In some examples, at least one instruction in the fused load instruction sequence is converted to a no-operation instruction in the split load instruction sequence. In some examples, replacing the fused load instruction sequence with the split load instruction sequence further comprises replacing the fused load instruction sequence with the split load instruction sequence as an entry for a load macro-operation in an operation cache.

In some examples, replacing the fused load instruction sequence with the split load instruction sequence further includes storing the split load instruction sequence in an operation cache that stores the fused load instruction sequence to decode a load macro-operation, and selecting the split load instruction sequence when decoding the load macro-operation.

In some examples, the control circuit is further configured to replace the fused load instruction sequence with the split load instruction sequence in response to a performance-based trigger corresponding to at least one of (a) a load-store unit (LSU) utilization rate being below an LSU utilization rate threshold, (b) a micro-operation dispatch rate exceeding a micro-operation dispatch rate threshold, (c) a distribution of load sources, or (d) a memory traffic for a memory controller satisfying a memory traffic threshold.

In one implementation, a method for load instruction division includes (i) detecting, in an instruction pipeline, a first load instruction sequence for a plurality of registers that includes a load instruction for loading a target load from contiguous memory locations and a shift instruction for loading a desired portion of the target load into a desired register of the plurality of registers, (ii) converting the load instruction into separate load instructions for loading each of the contiguous memory locations into respective registers of the plurality of registers, (iii) removing the shift instruction in a second load instruction sequence that includes the separate load instructions, and (iv) replacing the first load instruction sequence with the second load instruction sequence in the instruction pipeline.

In some examples, removing the shift instruction further comprises converting the shift instruction into a no-operation instruction in the second load instruction sequence. In some examples, replacing the first load instruction sequence with the second load instruction sequence further comprises using the second load instruction sequence instead of the first load instruction sequence for decoding a load macro-operation. In some examples, replacing the first load instruction sequence with the second load instruction sequence is in response to a performance-based trigger corresponding to at least one of (a) a load-store unit (LSU) utilization rate being below an LSU utilization rate threshold, (b) a micro-operation dispatch rate exceeding a micro-operation dispatch rate threshold, (c) a distribution of load sources, or (d) a memory traffic for a memory controller satisfying a memory traffic threshold.

Features from any of the implementations described herein can be used in combination with one another in accordance with the general principles described herein. These and other implementations, features, and advantages will be more fully understood upon reading the following detailed description in conjunction with the accompanying drawings and claims.

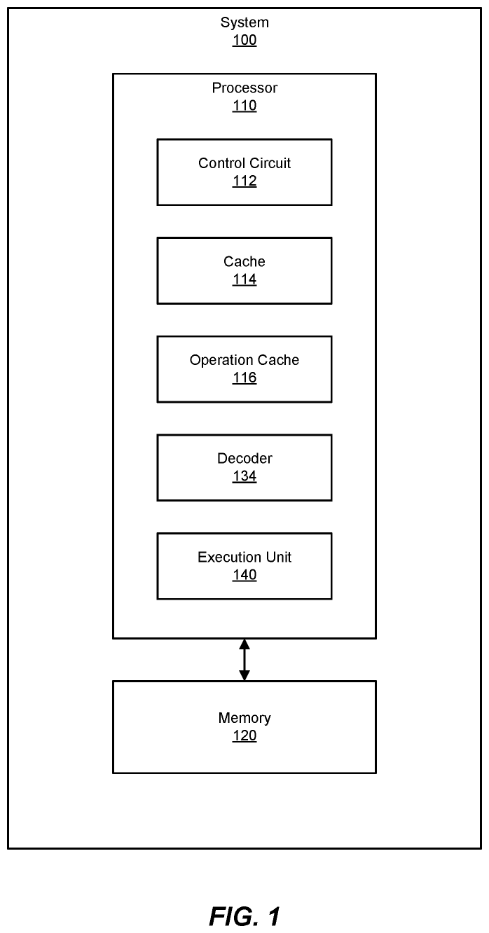

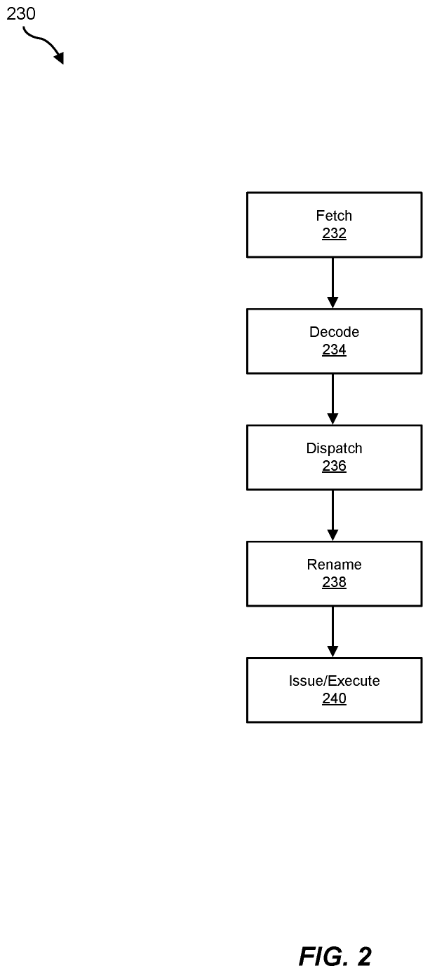

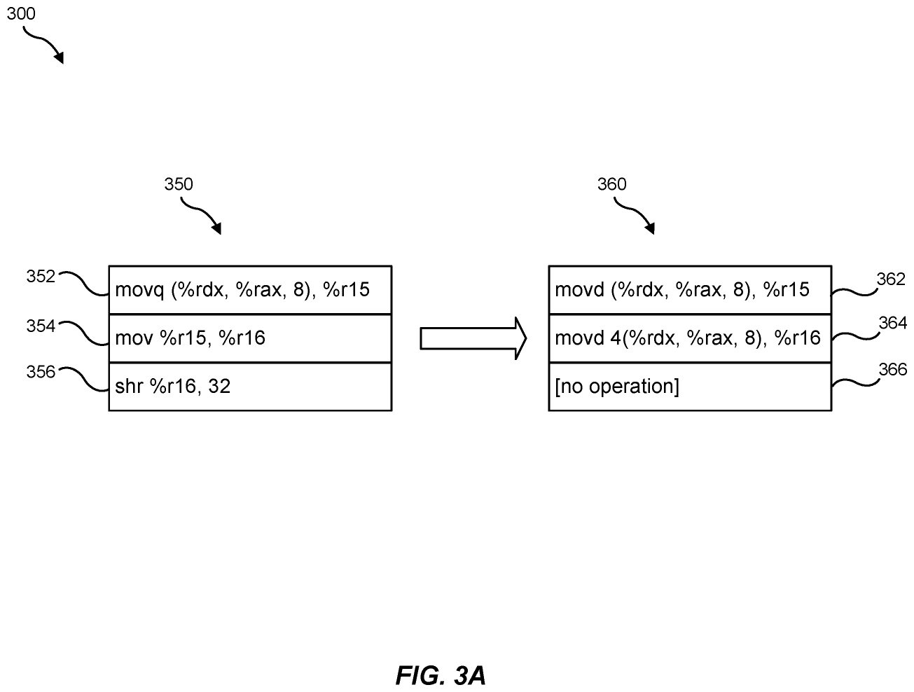

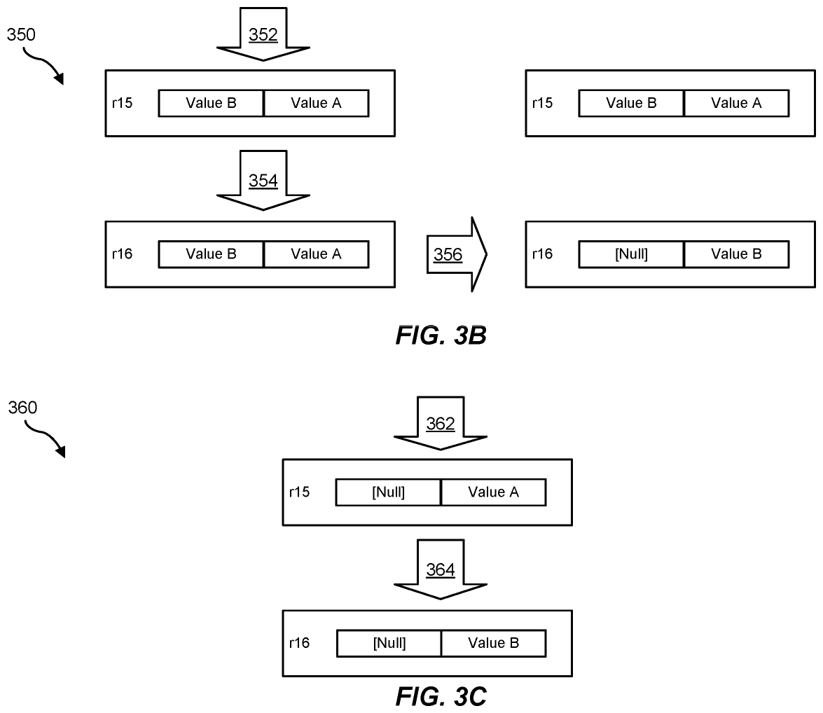

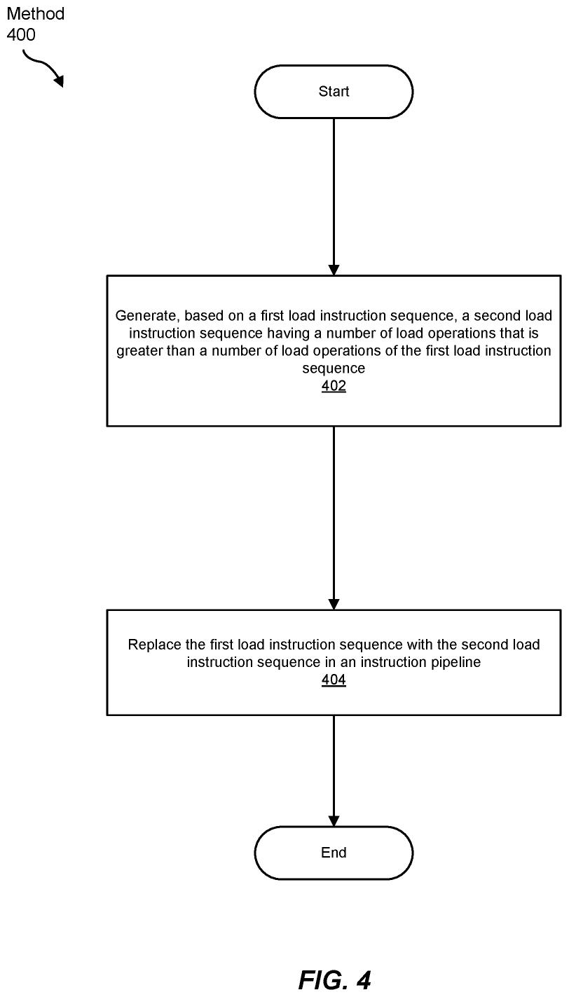

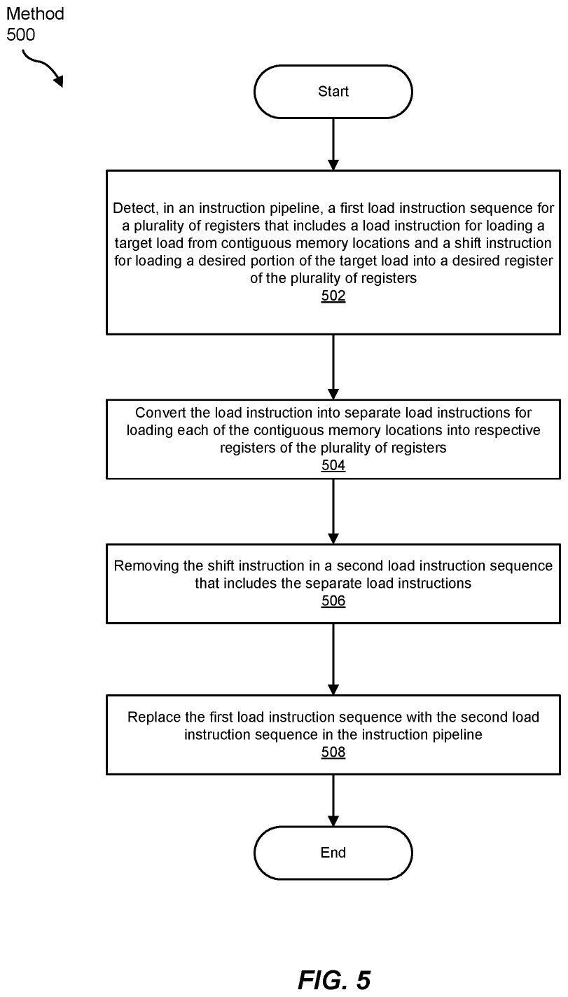

The following will provide, with reference to FIGS. 1-5, detailed descriptions of load instruction division. Detailed descriptions of example systems will be provided in connection with FIGS. 1 and 2. Detailed descriptions of example instruction division will be provided in connection with FIGS. 3A-C. Detailed descriptions of corresponding computer-implemented methods will also be provided in connection with FIGS. 4 and 5.

FIG. 1 is a block diagram of an example system 100 for load instruction division. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), co-processors such as digital signal processors (DSPs), Neural Network Engines (NNEs), accelerators, portions of one or more of the same, variations or combinations of one or more of the same (e.g., a host processor and a co-processor), and/or any other suitable physical processor(s).

In some implementations, the term “instruction” refers to computer code that can be read and executed by a processor. Examples of instructions include, without limitation, macro-instructions/macro-operations (e.g., program code that requires a processor to decode into processor instructions that the processor can directly execute) and micro-operations (e.g., low-level processor instructions that can be decoded from a macro-instruction and that form parts of the macro-instruction). In some implementations, micro-operations correspond to the most basic operations achievable by a processor and therefore can further be organized into micro-instructions (e.g., a set of micro-operations executed simultaneously).

As further illustrated in FIG. 1, processor 110 includes a control circuit 112, a cache 114, an operation cache 116, as well as various other functional units such as a decoder 134, and an execution unit 140. Control circuit 112 corresponds to circuitry and/or instructions for dividing load operations (e.g., instructions for loading values from memory/cache into registers, which can correspond to macro-instructions and/or micro-operations), as will be described further below. In some examples, control circuit 112 can also combine load operations, which can subsequently be divided (e.g., a reverse of the load operation division described herein).

Cache 114 corresponds to a local storage used by processor 110 (e.g., a client-side cache such as a low-level cache or L1 cache) for holding data/instructions from a memory device such as memory 120. In some examples, cache 114 corresponds to and/or includes other caches, such as a memory-side cache. Further, cache 114 can correspond to a cache hierarchy, having multiple levels of caches that in some implementations can have different properties (e.g., lower-level caches such as L1 being smaller yet faster compared to higher-level caches such as L2 and above being progressively larger yet slower).

Operation cache 116 corresponds to a storage for holding decoded instructions. Decoder 134 corresponds to a circuit for decoding instructions. Execution unit 140 corresponds to a logic or arithmetic unit which can perform decoded instructions. In some examples, execution unit 140 (and corresponding instructions) can correspond to a scalar unit for operating on single data elements (as operands), or a vector unit for operating on arrays of data element (as operands, which in some implementations further includes circuitry and/or instructions for vector operations). In some implementations, control circuit 112 can include or otherwise interface with decoder 134.

In some examples, processor 110 (and/or a functional unit thereof) reads program instructions (e.g., macro-operations) from memory 120 and decodes (e.g., by decoder 134) the read program instructions into micro-operations, which in some examples can include finding a corresponding decoded entry (e.g., a sequence of micro-operations) in operation cache 116. In some implementations, processor 110 (and/or a functional unit thereof) can send the newly decoded micro-operations to an appropriate execution unit of processor 110 (e.g., execution unit 140) when available to execute micro-operations as part of an instruction pipeline (a sequences of stages for a processor to perform instructions), as will be described further below.

FIG. 2 illustrates an exemplary instruction pipeline 230 for a processor, such as processor 110 (and/or a functional unit thereof), for executing instructions. During a fetch stage 232, processor 110 can read program instructions from memory 120 and/or cache 114. Processor 110 can fetch program instructions based on an active thread or other criteria. At decode stage 234, processor 110 can decode (e.g., using decoder 134 and/or operation cache 116) the read program instructions into micro-operations. Processor 110 (and/or a functional unit thereof) can forward the newly decoded micro-operations to a scheduler that can queue micro-operations until they are ready for dispatch. At dispatch stage 236, the scheduler can dispatch one or more micro-operations that are ready for dispatch. At rename stage 238, processor 110 can allocate registers to the dispatched micro-operation as needed. At issue/execute stage 240, processor 110 and/or an execution unit thereof (e.g., execution unit 140) executes the dispatched micro-operations.

Although FIG. 2 illustrates a basic example instruction pipeline 230, in other examples processor 110 can include additional or fewer stages, perform the stages in various orders, repeat iterations, and/or perform stages in parallel. For instance, as an instruction proceeds through the stages, a next instruction can follow so as not to leave a stage inactive.

As described herein, certain workloads can create certain performance bottlenecks that can reduce computing performance. For example, for memory-intensive workloads, instructions for loading data from memory/cache (which incur latency that can relate to available memory bandwidth) can other cause instructions that are dependent on the loads to wait for the loads. In some implementations, to reduce a number of loads, control circuit 112 can combine load instructions into a larger load instruction. Control circuit 112 can identify (e.g., via memory addresses, and in some implementations via separate flagging instructions as implemented with software and/or compiler support) multiple load instructions for contiguous memory locations that can be combined into a larger single load. For instance, two scalar values (e.g., double words) can be combined into a larger scalar value (e.g., a quad word) for loading from memory, to reduce a number of load instructions. Similarly, two vectors can be combined into a larger vector for loading from memory.

Combining or fusing loads as described can require additional operations for loading portions of the larger value into appropriate registers of the original size. However, these additional operations can require an execution unit for completion. For compute-intensive workloads, these additional operations can unfavorably reduce dispatch bandwidth (e.g., having less execution units available for instructions). Dividing load operations can improve dispatch bandwidth. FIGS. 3A-3C illustrate how load operations can be divided.

FIG. 3A illustrates a decoding 300 of a load macro-operation into micro-operations as can be performed by decoder 134 using operation cache 116. FIG. 3A includes a first load instruction sequence 350 (e.g. a fused load instruction sequence) and a second load instruction sequence 360 (e.g., a split load instruction sequence). First load instruction sequence 350 can include micro-operations, such as an instruction 352, an instruction 354, and an instruction 356. Second load instruction sequence 360 can include micro-operations, such as an instruction 362, an instruction 364, and an instruction 366.

First load instruction sequence 350 can correspond to a sequence of micro-operations when decoding a load macro-operation (e.g., for loading multiple scalars and/or vectors). For example, at decode stage 234, the load instruction (e.g., an instruction such as a micro-operation for reading a value from memory/cache into a register) fetched at fetch stage 232 can be decoded by decoder 134 (e.g., by looking for a matching entry in operation cache 116), into first load instruction sequence 350. First load instruction sequence 350 can correspond to an instruction sequence designed to reduce loads, which in some examples can correspond to a previously fused load instruction sequence as described above.

In FIG. 3A, first load instruction sequence 350 includes a large load (e.g., corresponding to loading multiple registers' worth of data with a single load, such as loading a quadword for two doubleword registers) into registers r15 and r16. In some implementations, registers can be mapped (e.g., at rename stage 238) to different physical registers as needed (e.g., based on the instructions such that a register such as r15 and/or r16 are mapped to appropriately sized physical registers). More specifically, first load instruction sequence 350 corresponds to loading different double words (which can be located in contiguous memory locations) into registers r15 and r16, respectively.

Instruction 352 defines a size of a load, what address to load from, and where to load to (destination), further corresponding to loading a quadword into register r15 as read from the address calculated from values from registers rdx and rax (e.g., rdx+rax*8). FIG. 3B further illustrates first load instruction sequence 350 as a conceptual block diagram, illustrating how Value A (a doubleword) can be loaded into register r15 and Value B (a doubleword) can be loaded into register r16. Instruction 352 includes loading two doublewords (e.g., Value A and Value B) into register r15. When later reading the desired doubleword from register r15, because Value A is already loaded into the appropriate bit locations (e.g., lower bits, which can correspond to reading from right bits to left bits), the doubleword read from register r15 corresponds to Value A, and Value B can remain unread/unused from register r15.

Instruction 354 corresponds to copying the quadword in register r15 into register r16. However, if reading a doubleword from register r16, Value A (rather than the desired Value B) would be read, based on the bit locations. Thus, an additional correcting operation is needed to ensure the desired value is read. Instruction 356 corresponds to shifting of bits by an appropriate amount (e.g., shifting bits to the right by a doubleword size of 32 bits), resulting in the desired Value B in the appropriate bit location as illustrated in FIG. 3B. Although in this example the correcting operation corresponds to a shift operation (e.g., based on how bits are read from registers), in other examples one or more other correcting operations can be used as needed.

As a result of first load instruction sequence 350, the desired doubleword (e.g., Value A) is readable from register r15 and the desired doubleword (e.g., Value B) is readable from register r16. First load instruction sequence 350 can use a single load instruction (e.g., instruction 352) rather than two load instructions (e.g., one for each of registers r15 and r16) to reduce a number of load instructions. However, first load instruction sequence 350 requires a correcting operation (e.g., instruction 356) that requires an execution unit to complete, reducing execution unit availability which can further reduce a micro-operation dispatch rate (e.g., a rate at which micro-operations are dispatched to execution units, indicating how many execution units are in use). In some compute-intensive workloads, a reduction of the micro-operation dispatch rate can correspond to stalling conditions (e.g., waiting for execution units to become available).

In some implementations, control circuit 112 can divide loads to improve computing performance (e.g., the micro-operation dispatch rate). Control circuit 112 can implement load instruction division in response to performance-based triggers (e.g., corresponding to target conditions for causing a response). In some examples, the trigger can correspond to a load-store unit (LSU) utilization rate (e.g., tracked by a number of LSU tokens in use), which can indicate a number of pending memory requests. In some examples, the trigger can correspond to the micro-operation dispatch rate (e.g., tracked by a number of dispatch tokens) as described herein. In some examples, the trigger can correspond to a distribution of load sources such as registers (e.g., which can relate to a number of instructions in the instruction pipeline). In some examples, the trigger can correspond to memory controller metrics (e.g., traffic volume, which can further be tracked at a socket/node level of a corresponding die).

In some implementations, control circuit 112 can include circuitry for tracking one or more trigger conditions (e.g., tracking tokens and/or comparing to thresholds as described herein), which can further track conditions over time and refresh periodically and/or whenever needed. Further, in some implementations, control circuit 112 can track conditions separately for each processing thread and respond independently for each thread.

Certain conditions can trigger load instruction division, such as a low LSU utilization rate (e.g., the LSU utilization rate being below a threshold, which can be indicative of available bandwidth for memory operations), and/or a high micro-operation dispatch rate (e.g., the micro-operation dispatch rate exceeding a threshold, which can be indicative of low bandwidth for logic/arithmetic operations), which correspond to scenarios where load instruction division can be beneficial (e.g., reducing correcting operations to improve the micro-operation dispatch rate without increasing the LSU utilization rate beyond an upper threshold). Other conditions can include, for example, a high distribution of load sources (e.g., which can benefit from minimizing a total number of instructions in the instruction pipeline).

For example, tracking the distribution of load sources can be used to jointly minimize the total number of remote loads (e.g., fusion for remote loads) and minimize the total number of instructions in the pipeline (e.g., fission for local loads) to save power and energy. In some implementations, monitoring memory controller/multi-core die metrics can be used to balance local (e.g., core) and global optimization across shared bandwidth resources. For example, if the memory controller is experiencing high traffic, throughput can be improved at the socket or node level by adjusting a mix of load fusion and load fission operations to relieve pressure in the shared resources, rather than considering only local (core) metrics in isolation.

In another example, if monitoring multiple threads simultaneously, a midrange or average dispatch rate across all simultaneous threads can obscure trends where one thread has a high dispatch rate and the other threads do not. Accordingly, the thread with the high dispatch rate can benefit from load instruction division to make more efficient use of its allocated space in shared structures, even when the other threads are less space constrained.

Once triggered to implement load instruction division, control circuit 112 can, in some examples, identify first load instruction sequence 350 as a memory instruction that can be divided based on flags (which can be based on compiler and/or source code based indicators/instructions), additional metadata (e.g., in operation cache 116), the memory locations and/or registers (e.g., a pattern of contiguous memory locations to be loaded into multiple registers such as a larger word size being loaded into smaller word size registers based on multiple loads in which source addresses are offset by register word size), the instruction sequence itself (e.g., identifying a shift instruction and/or other instruction needed to apportion a target load of a larger load into smaller portions for loading into registers), and/or other indications that a larger load can be broken into smaller loads.

Control circuit 112 can convert first load instruction sequence 350 into second load instruction sequence 360 by modifying/replacing instructions and/or creating a new instruction sequence. Instruction 362 corresponds to instruction 352 for loading a value into register r15, and retains the source address to load from (e.g., rdx+rax*8) and destination register (e.g., register r15) from instruction 352. However, instruction 362 corresponds to a reduced target load size (e.g., a doubleword rather than a quadword), as further illustrated in FIG. 3C. In some examples, register r15 (and register r16) can be mapped to physical registers of a doubleword size (as opposed to quadword size as in first load instruction sequence 350), although in other examples, register r15 and/or register r16 can be mapped to other larger sizes (e.g., quadword size) and only the appropriate portions (e.g., lower or right bits) used. Thus, register r15 can be loaded with Value A as desired.

Instruction 364 can correspond to instruction 354 for loading a value into register r16. For instance, instruction 364 can retain the destination (e.g., register r16) from instruction 354. However, rather than copying from register r15, instruction 364 reads the desired value (e.g., Value B) from the corresponding memory location (e.g., as was read in instruction 352 by combining contiguous memory locations). In some examples, control circuit 112 can calculate the appropriate source address using the same base address and applying an appropriate offset (e.g., 4 for a doubleword, resulting in 4+rdx+rax*8). In some implementations, control circuit 112 can dynamically determine the offset (e.g., based on difference is load/register size, flags/metadata, etc.) although in other implementations control circuit 112 can use a particular offset (e.g., corresponding to a specific ratio such as between quadword and doubleword). Accordingly, control circuit 112 can change instruction 354 into instruction 364 by changing at least an operand (e.g., from a source register to a source address). Value B can be loaded into register r16, as further illustrated in FIG. 3C.

Moreover, as registers r15 and r16 have already been loaded such that additional correcting operations are unneeded. Thus, control circuit 112 can change instruction 356 into instruction 366 (e.g., a no-operation instruction) or otherwise remove instruction 356. Accordingly, second load instruction sequence 360 corresponds to a larger load (e.g., instruction 352) split into smaller loads (e.g., instruction 362 and instruction 364) as well as a reduction of correcting operations (e.g., instruction 354 and/or instruction 356) while utilizing a same number of registers.

To replace first load instruction sequence 350 with second load instruction sequence 360 in an instruction pipeline (e.g., instruction pipeline 230), in some implementations control circuit 112 can replace first load instruction sequence 350 with second load instruction sequence 360 before decode stage 234 of a corresponding load macro-operation. In some implementations, control circuit 112 can update or otherwise overwrite an entry in operation cache 116 that maps to the load macro-operation. In other implementations, control circuit 112 can store both first load instruction sequence 350 and second load instruction sequence 360 in operation cache 116 (mapping to the same load macro-operation) and arbitrate or otherwise select between the two as needed. For instance, control circuit 112 can establish a pointer to the appropriate instruction sequence, which can be updated based on the performance-based triggers described herein (e.g., pointing to second load instruction sequence 360 when the triggers are met and pointing to first load instruction sequence 350 otherwise). In yet other examples, control circuit 112 can dynamically select (e.g., at decode stage 234) between the two based on the performance-based triggers.

Although FIGS. 3A-3C illustrate examples using doublewords (which can be combined into quadwords), in other examples other appropriate data sizes can be used, such as other word sizes, vectors, etc. For example, vector instructions/registers can be analogously used in place of the doubleword/quadword instructions/registers described with respect to FIGS. 3A-3C, with control circuit 112 applying appropriate offsets. Moreover, although FIGS. 3A-3C illustrate control circuit 112 generating a single load instruction sequence from the original load instruction sequence, in other examples, control circuit 112 can generate additional load instruction sequences (e.g., such that control circuit 112 can select between multiple load instruction sequences and/or generate different versions for different threads, etc.).

FIG. 4 is a flow diagram of an exemplary computer-implemented method 400 for dividing load instructions. The steps shown in FIG. 4 can be performed by any suitable computer-executable code and/or computing system, including the system(s) illustrated in FIGS. 1 and/or 2. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein generate, based on a first load instruction sequence, a second load instruction sequence having a number of load instructions that is greater than a number of load instructions of the first load instruction sequence. For example, control circuit 112 can generate second load instruction sequence 360 based on first load instruction sequence 350, as described herein, such that second load instruction sequence 360 includes more load instructions than first load instruction sequence 350.

The systems described herein can perform step 402 in a variety of ways. In one example, generating the second load instruction sequence (e.g., second load instruction sequence 360) includes splitting or converting a load instruction (e.g., instruction 352) for contiguous memory locations (e.g., consecutive doublewords) in the first load instruction sequence (e.g., first load instruction sequence 350) into separate load instructions (e.g., instruction 362 and instruction 364) for the contiguous memory locations. In some examples, converting the load instruction can include converting additional instructions (e.g., converting instruction 354 into instruction 364 as part of converting instruction 352).

Further, in some examples, the first load instruction sequence can correspond to a scalar (e.g., operations involving scalar operands). In some examples, the first load instruction sequence corresponds to a vector (e.g., operations involving vector operands).

At step 404 one or more of the systems described herein replace the first load instruction sequence with the second load instruction sequence in an instruction pipeline. For example, control circuit 112 can replace first load instruction sequence 350 with second load instruction sequence 360 in instruction pipeline 230.

The systems described herein can perform step 404 in a variety of ways. In one example, the control circuit (e.g., control circuit 112) is configured to replace the first load instruction sequence with the second load instruction sequence before a decode stage (e.g., decode stage 234) of the instruction pipeline (e.g., instruction pipeline 230).

In some implementations, replacing the first load instruction sequence with the second load instruction sequence further includes replacing the first load instruction sequence with the second load instruction sequence in an operation cache (e.g., operation cache 116). In some implementations, replacing the first load instruction sequence with the second load instruction sequence includes storing the second load instruction sequence in an operation cache that stores the first load instruction sequence to decode a load macro-operation and selecting the second load instruction sequence when decoding the load macro-operation, as described herein.

Moreover, in some examples, the control circuit is further configured to replace the first load instruction sequence with the second load instruction sequence in response to a performance-based trigger. As described herein, the performance-based trigger can correspond to an LSU utilization rate satisfying an LSU utilization rate threshold and a micro-operation dispatch rate being below a microoperation dispatch rate threshold, and in some examples can correspond to a distribution of load sources and/or a memory traffic (e.g., corresponding to read/write requests for a memory) for a memory controller satisfying a memory traffic threshold (e.g., the memory traffic being below the memory traffic threshold).

FIG. 5 is a flow diagram of an exemplary computer-implemented method 500 for dividing load instructions. The steps shown in FIG. 5 can be performed by any suitable computer-executable code and/or computing system, including the system(s) illustrated in FIGS. 1 and/or 2. In one example, each of the steps shown in FIG. 5 represent an algorithm whose structure includes and/or is represented by multiple sub-steps, examples of which will be provided in greater detail below.

As illustrated in FIG. 5, at step 502 one or more of the systems described herein detect, in an instruction pipeline, a first load instruction sequence for a plurality of registers that includes a load instruction for loading a target load from contiguous memory locations and a shift instruction for loading a desired portion of the target load into a desired register of the plurality of registers. For example, control circuit 112 can detect, in instruction pipeline 230, first load instruction sequence 350 that includes the load instruction (e.g., instruction 352) and the shift instruction (e.g., instruction 356).

At step 504 one or more of the systems described herein convert the load instruction into separate load instructions for loading each of the contiguous memory locations into respective registers of the plurality of registers. For example, control circuit 112 can convert instruction 352 into instruction 362 and instruction 364. In some examples, converting instructions can include replacing instructions (e.g., replacing instruction 352 with instruction 362 and replacing instruction 354 with instruction 364).

At step 506 one or more of the systems described herein remove the shift instruction in a second load instruction sequence that includes the separate load instructions. For example, control circuit 112 can remove instruction 356.

The systems described herein can perform step 506 in a variety of ways. In one example, removing the shift instruction (e.g., instruction 356) further includes converting the shift instruction into a no-operation instruction (e.g., instruction 366) in the second load instruction.

At step 508 one or more of the systems described herein replace the first load instruction sequence with the second load instruction sequence in the instruction pipeline. For example, control circuit 112 can replace first load instruction sequence 350 with second load instruction sequence 360 in instruction pipeline 230.

The systems described herein can perform step 508 in a variety of ways. In one example, replacing the first load instruction sequence (e.g., first load instruction sequence 350) with the second load instruction sequence (e.g., second load instruction sequence 360) further includes using the second load instruction sequence instead of the first load instruction for decoding a load macro-operation (e.g., at decode stage 234).

In some examples, replacing the first load instruction sequence with the second load instruction sequence is in response to a performance-based trigger corresponding to at least one of an LSU utilization rate satisfying an LSU utilization rate threshold, a micro-operation dispatch rate being below a micro-operation dispatch rate threshold, a distribution of load sources, and/or a memory traffic for a memory controller satisfying a memory traffic threshold, as described herein.

As described herein, load throughput is generally accepted as a performance bottleneck in the computer architecture field. Several optimizations have proposed hardware structures and compiler support to reduce loads issued in memory-bound applications. For example, the compiler can identify eligible loads and fuse them. However, some optimizations can lead to increased dynamic instruction count, which can have an inadvertent impact on compute-intensive applications by throttling valuable execution resources. The load instruction division described herein provide for dynamically breaking optimized scalar or vector loads into multiple load operations during runtime to reduce execution port pressure. This load instruction division can advantageously improve instruction throughput, further improving performance and efficiency in systems by executing fewer dynamic instructions.

In memory-bound workloads, increasing load throughput can be critical to improving performance. In some instances, fusing loads that are smaller than the corresponding destination registers size (e.g.: 32b load to an 64b scalar register or 256b load into a 512b register) can improve load throughput. Such fusions often involve adding instructions into the dynamic stream to ensure that register dependencies in the original stream are obeyed.

For example, in reference to FIGS. 3A-3C, the two loads in the original instruction stream (which can resemble instruction 362 and instruction 364) load 32b values into registers r15 and r16. As the doubleword loads are to contiguous memory locations, they can fused into a single quadword load (e.g., instruction 352). A move (e.g., instruction 354) from the new load's destination register to the second register and a shift (e.g., instruction 356) ensures that the originally loaded value is placed into the correct register, thus preserving dependencies in the original stream. While this example discusses scalar loads, a similar approach is applicable to vector loads (e.g.: fusing two 128b loads into a single 256b load) as well.

However, in this example the number of instructions increased by 33% in the example code, which in more complicated/realistic workloads can increase the number of dynamic instructions significantly, particularly for compute-intensive workloads, as the execution units would need to be utilized more for effective computation rather than consumed with adjustments for infrequent moves. Thus, the fused load instruction stream reduces instruction throughput and the effective dispatch rate for instructions that can be critical to the compute kernel, which can further be inflated if the fusion occurs in inner loops that execute frequently.

The present disclosure provides systems and methods for dividing or converting large load sequences into smaller load sequences, which reduces the number of dynamic instructions executed, improving performance in throughput-sensitive compute workloads.

In some implementations, compiler support can facilitate load instruction division. Examples of this include reordering loads to enable load instruction combining by the compiler (e.g., merging two 32b loads to one 64b load), which can then be divided during runtime.

Converting the large load instruction sequence (e.g., first load instruction sequence 350 in FIGS. 3A-3B) to a smaller load sequence (e.g., second load instruction sequence 360 in FIGS. 3A and 3C) can require a new pop (micro-operation) sequence to be issued. Accordingly, the conversion can take place in or prior to the decode stage (e.g., decode stage 234) of the CPU pipeline (e.g., instruction pipeline 230). Decoders (e.g., decoder 134) can convert a single instruction or macro-op (macro-operation) into multiple micro-ops (micro-operations). Moreover, certain macro-op sequences (such as a jump & compare) can be converted to one or more micro-ops. Accordingly, a decoder can convert the target load to multiple smaller loads as described herein.

Referring again to FIGS. 3A-3C, the target load to divide (e.g., the target load of instruction 352) contains the base address to load from and the size of the load (e.g., movq indicating a quadword (64b) load). This information is required to generate the new load sequence. In this example, the upper 32b and lower 32b were issued as a single load but need to be moved to the correct registers. Therefore, instruction 354 copies the load value into a new register, and instruction 356 shifts the load value by 32 to move the correct 32b value to r16. The source register in instruction 354 (e.g., r15) is the destination register of the first load (e.g., instruction 362), while the destination register in instruction 354 (r16) is the destination register of the second load (e.g., instruction 364). In this example, the offset of the second load can be determined by enforcing a 1:2 load fission or dividing the shift in instruction 356 by 8. Once the information on the new load micro-ops has been collected, second load instruction sequence 360 can be generated and stored in the op cache (e.g., operation cache 116). Thus, the target load of instruction 352 can then be converted to a smaller move (e.g., instruction 362), and the move in instruction 354 can be converted to a load (e.g., instruction 364) where the source operand has been modified. Instruction 356 can then be converted to a no-operation (no-op) and will not be executed or consume dispatch bandwidth.

Once the micro-op sequence has been generated, it can be stored in the op cache, as described herein. In one implementation, micro-op sequence in the op cache that maps to the macro-op sequence can be overwritten when load fission is triggered. In another implementation, both the original and the modified micro-op sequence can be stored in the op cache and map to the same input sequence, allowing for loads to remain combined/fused in memory-bound phases and divided/fissioned in compute-intensive phases. Arbitration between which sequence to select for dispatch when accessing the op cache can determined by the triggers described herein.

For example, when LSU utilization is low and the micro-op dispatch rate is high, load fission can be beneficial. When LSU utilization is high and the dispatch rate is low, the fused sequence can be more beneficial for performance. When both LSU utilization and the dispatch rate are high, the most recent program behavior can be used to arbitrate between selecting the fused or unfused load micro-op sequences. In one example, if either of the two metrics reach a certain threshold, load fission can be performed. In another example, circuitry that tracks both metrics over a specified time period can be refreshed periodically to evaluate recent program behavior. In some examples, dispatch rate can be tracked by the number of dispatch tokens in use in the processor, and LSU utilization can be determined by the number of LSU tokens in use. The circuitry (e.g., one or more counters) can sample these values and indicate to the decoder which sequence (e.g., first load instruction sequence 350 or second load instruction sequence 360) to fetch from the op cache.

Dividing vector loads can, in addition to performance improvements with a reduced number of instructions executed, provide a power efficiency benefit as the vector execution lanes can require more energy to compute over larger data sizes. The utilization metrics and op cache organization can be performed similarly as the discussed examples.

As detailed above, the computing devices and systems described and/or illustrated herein broadly represent any type or form of computing device or system capable of executing computer-readable instructions, such as those contained within the modules/memory devices described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a control circuit configured to:
generate, based on a first load instruction sequence, a second load instruction sequence having a number of load instructions that is greater than a number of load instructions of the first load instruction sequence; and
replace the first load instruction sequence with the second load instruction sequence in an instruction pipeline.

2. The device of claim 1, wherein generating the second load instruction sequence includes converting a load instruction for contiguous memory locations in the first load instruction sequence into separate load instructions for the contiguous memory locations.

3. The device of claim 1, wherein the control circuit is configured to replace the first load instruction sequence with the second load instruction sequence before a decode stage of the instruction pipeline.

4. The device of claim 1, wherein replacing the first load instruction sequence with the second load instruction sequence further comprises replacing the first load instruction sequence with the second load instruction sequence in an operation cache.

5. The device of claim 1, wherein replacing the first load instruction sequence with the second load instruction sequence further comprises:
storing the second load instruction sequence in an operation cache that stores the first load instruction sequence to decode a load macro-operation; and
selecting the second load instruction sequence when decoding the load macro-operation.

6. The device of claim 1, wherein the control circuit is further configured to replace the first load instruction sequence with the second load instruction sequence in response to a performance-based trigger.

7. The device of claim 6, wherein the performance-based trigger corresponds to a load-store unit (LSU) utilization rate being below an LSU utilization rate threshold and a micro-operation dispatch rate exceeding a micro-operation dispatch rate threshold.

8. The device of claim 6, wherein the performance-based trigger corresponds to a distribution of load sources.

9. The device of claim 6, wherein the performance-based trigger corresponds to a memory traffic for a memory controller satisfying a memory traffic threshold.

10. The device of claim 1, wherein the first load instruction sequence corresponds to a scalar.

11. The device of claim 1, wherein the first load instruction sequence corresponds to a vector.

12. A system comprising:
a memory;
a processor having a plurality of registers; and
a control circuit configured to:
identify a fused load instruction sequence for the plurality of registers that includes a load instruction for loading from multiple memory locations;
generate a split load instruction sequence by converting the load instruction into separate load instructions for each of the multiple memory locations into respective registers of the plurality of registers; and
replace the fused load instruction sequence with the split load instruction sequence.

13. The system of claim 12, wherein at least one instruction in the fused load instruction sequence is converted to a no-operation instruction in the split load instruction sequence.

14. The system of claim 12, wherein replacing the fused load instruction sequence with the split load instruction sequence further comprises replacing the fused load instruction sequence with the split load instruction sequence as an entry for a load macro-operation in an operation cache.

15. The system of claim 12, wherein replacing the fused load instruction sequence with the split load instruction sequence further comprises:
storing the split load instruction sequence in an operation cache that stores the fused load instruction sequence to decode a load macro-operation; and
selecting the split load instruction sequence when decoding the load macro-operation.

16. The system of claim 12, wherein the control circuit is further configured to replace the fused load instruction sequence with the split load instruction sequence in response to a performance-based trigger corresponding to at least one of:
a load-store unit (LSU) utilization rate being below an LSU utilization rate threshold;
a micro-operation dispatch rate exceeding a micro-operation dispatch rate threshold;
a distribution of load sources; or
a memory traffic for a memory controller satisfying a memory traffic threshold.

17. A method comprising:
detecting, in an instruction pipeline, a first load instruction sequence for a plurality of registers that includes a load instruction for loading a target load from contiguous memory locations and a shift instruction for loading a desired portion of the target load into a desired register of the plurality of registers;
converting the load instruction into separate load instructions for loading each of the contiguous memory locations into respective registers of the plurality of registers;
removing the shift instruction in a second load instruction sequence that includes the separate load instructions; and
replacing the first load instruction sequence with the second load instruction sequence in the instruction pipeline.

18. The method of claim 17, wherein removing the shift instruction further comprises converting the shift instruction into a no-operation instruction in the second load instruction sequence.

19. The method of claim 17, wherein replacing the first load instruction sequence with the second load instruction sequence further comprises using the second load instruction sequence instead of the first load instruction sequence for decoding a load macro-operation.

20. The method of claim 17, wherein replacing the first load instruction sequence with the second load instruction sequence is in response to a performance-based trigger corresponding to at least one of:
a load-store unit (LSU) utilization rate being below an LSU utilization rate threshold;
a micro-operation dispatch rate exceeding a micro-operation dispatch rate threshold;
a distribution of load sources; or
a memory traffic for a memory controller satisfying a memory traffic threshold.
